(19) United States
(12) Patent Application Publication
(10) Pub. No.: US 2025/0382015 A1
(43) Pub. Date: Dec. 18, 2025

(54) VEHICLE BODY ASSEMBLY WITH INTEGRATED ATTACHMENTS

(71) Applicant: MAGNA INTERNATIONAL INC., Aurora (CA)

(72) Inventors: Ian PATTERSON, Novi, MI (US); Venugopal GARIMELLA, Troy, MI (US); Shrikanth GUJJAL, Rochester Hills, MI (US)

(21) Appl. No.: 19/239,129

(22) Filed: Jun. 16, 2025

Related U.S. Application Data
(60) Provisional application No. 63/660,630, filed on Jun. 17, 2024.

(51) Int. Cl. B62D 25/08; B60K 1/00

(52) U.S. Cl. CPC B62D 25/082; B60K 1/00

(57) ABSTRACT

A vehicle body assembly includes a body in white structure that has a front portion and a pair of front rails that extend in spaced and parallel relationship with one another at the front portion. An electric motor that has a motor housing casting is coupled to the front rails of the body in white structure. The motor housing casting includes at least one attachment for connecting to vehicle components.

### CROSS REFERENCE TO RELATED APPLICATIONS

This U.S. Non-Provisional patent application claims the benefit of and priority to U.S. Provisional Application Ser. No. 63/660,630 filed Jun. 17, 2024, the entire disclosure of which is hereby incorporated by reference in its entirety.

### FIELD OF THE DISCLOSURE

The present disclosure relates to vehicles, such as automobiles. More particularly, the present disclosure relates to body assemblies for mounting vehicle components.

### BACKGROUND

Vehicles like automobiles typically have a body assembly which constitutes the main supporting structure for components of the vehicle. FIG. 1 shows an example body assembly 10 for an electric motor powered vehicle. The body assembly 10 is shown at a body in white (BIW) stage of production of the vehicle in which the body assembly 10 has been joined together, but prior to the integration of components like the electric motor, cradle chassis sub-assemblies and trim into the vehicle. The body assembly 10 has a pair of front rails 12 that extend in spaced and parallel relationship with one another in a lengthwise direction of the vehicle at a front region of the vehicle. A generally rectangular shaped cradle 14 is secured under the front rails 12. The cradle 14 is formed of a series of connected components which are configured to support different features of the vehicle. In particular, the cradle 14 has steering gear mounts 16, electric motor mounts 18, sway bar mounts 20 and control arm mounts 22. There remains a need for improvements to vehicle bodies 10 and cradles 14, particularly for electric vehicles. Of note, there remains a need to make vehicles bodies 10 and cradles 14 cheaper and easier to manufacture.

### SUMMARY OF THE DISCLOSURE

According to an aspect of the disclosure, a vehicle body assembly includes a body in white structure that has a front portion and a pair of front rails that extend in spaced and parallel relationship with one another at the front portion. An electric motor that has a motor housing casting is coupled to the front rails of the body in white structure. The motor housing casting includes at least one attachment for connecting to vehicle components.

The presence of the attachments on the motor housing casting of the electric motor reduces the number of components on the body assembly and simplifies construction of the body assembly, as there is no need for a multi-piece cradle assembly to hold components. Instead, all of the attachments are connected to the motor housing casting, such that the motor housing casting serves as a cradle assembly.

According to another aspect of the disclosure, a vehicle body assembly includes a body in white structure that has a front portion. The body in white structure includes a pair of front rails at the front portion. The front rails extend in spaced and parallel relationship with one another. The front rails each have a top surface and a bottom surface. A pair of cross members are coupled to the bottom surfaces of the pair of front rails. The cross members extend transversely to the front rails in spaced relationship with one another. The cross member includes at least one attachment for connecting to vehicle components.

Again, the arrangement of the front rails and cross members reduces the number of components on the body assembly and simplifies construction of the body assembly, as there is no need for a multi-piece cradle assembly to hold components.

According to another aspect of the disclosure, a method of assembling a vehicle body assembly includes connecting a pair of cross members to a pair of front rails. The cross members extend transversely to the front rails to form a cradle assembly. The method also includes coupling the front rails to a body in white structure of the vehicle body assembly after connecting the pair of cross members to the pair of front rails. The method also includes attaching at least one vehicle components to at least one attachment on the cross members.

According to this method, the front rails and cross members may be fabricated separately from the rest of the body in white structure, and conveniently connected to the body in white structure.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a perspective view of a front cradle and body assembly for an example electric vehicle;

FIG. 1A is perspective view of the front cradle of FIG. 1;

FIG. 2 is a top view of a first embodiment of a vehicle body assembly and a front cradle integrated into an electric motor housing according to an aspect of the present disclosure;

FIG. 2A is a perspective view of the first embodiment of the vehicle body assembly and front cradle integrated into the electric motor housing;

FIG. 3 is a perspective view of a second embodiment of a vehicle body assembly with an integrated front cradle according to an aspect of the disclosure;

FIG. 4A is a perspective view of a body in white structure of a third embodiment of the vehicle body assembly;

FIG. 4B is a perspective view of connectable front rails and cross members of the third embodiment of the vehicle body assembly; and

FIG. 4C is a perspective view of the assembled front rails and cross members and body in white structure of the third embodiment of the vehicle body assembly.

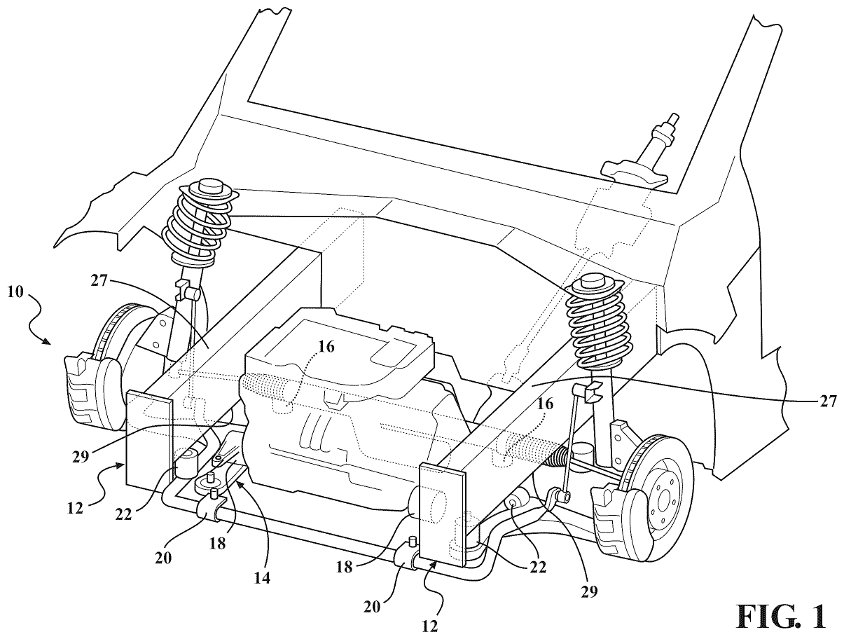

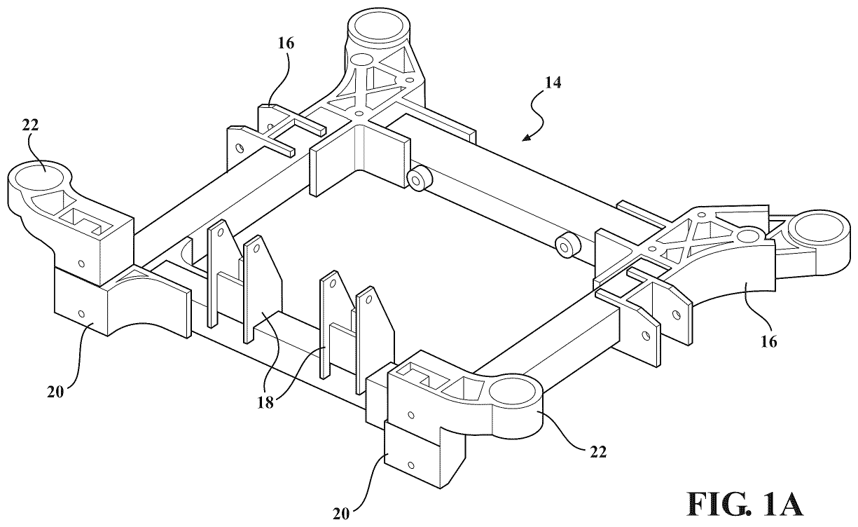

### DESCRIPTION OF THE ENABLING EMBODIMENT

Referring to the figures, wherein like numerals indicate corresponding parts throughout the several views, embodiments of a vehicle body assembly 30A, 30B, 30C for a vehicle are provided. The vehicle body assembly 30A, 30B, 30C according to the preferred embodiments is used on an electric automobile, but teachings of the present disclosure may also be applied to other types of vehicles, e.g., recreation vehicles, and with different types of powertrains, e.g., an internal combustion engine.

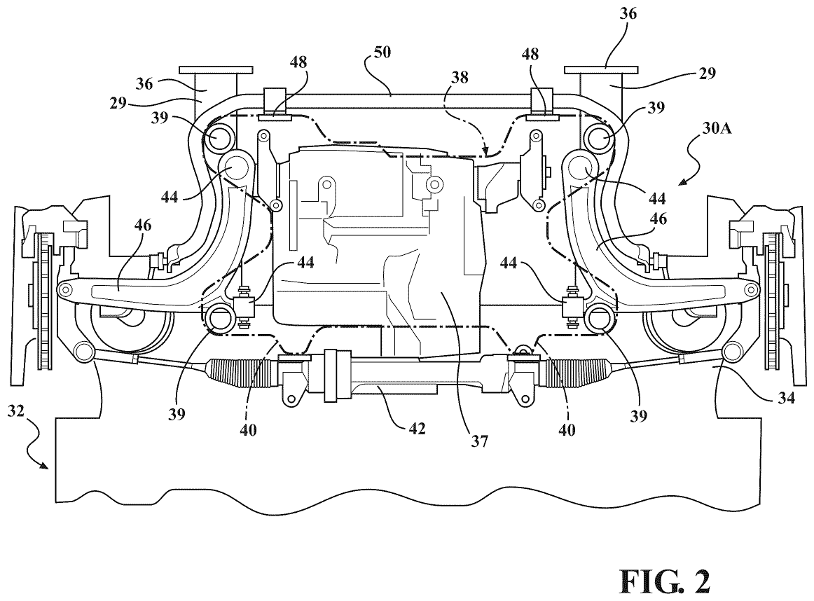

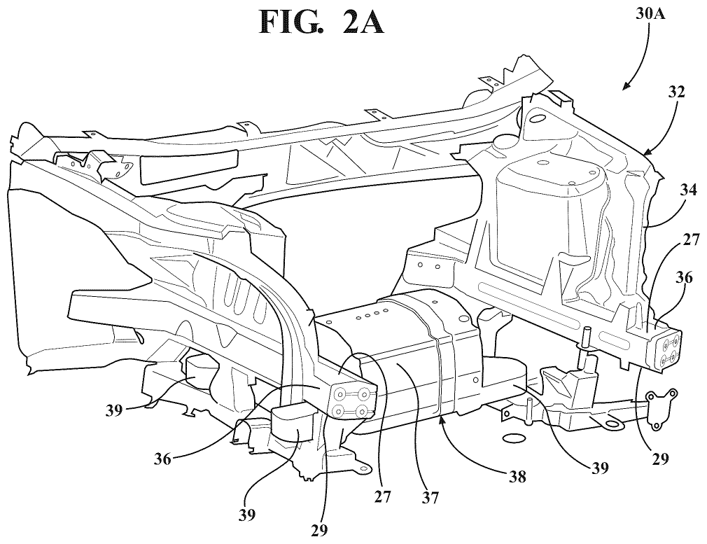

A first embodiment of the body assembly 30A is shown in FIGS. 2-2A. The body assembly 30A includes a body in white structure 32 that has a front portion 34 at a hood region of the vehicle. A pair of front rails 36 extend in spaced and parallel relationship with one another at the front portion 34. The front rails 36 each have a top surface 27 and a bottom surface 29. Although the preferred embodiments of the present disclosure are directed to the front portion 34 of the vehicle, the teachings of the present disclosure may also be directed to other parts of the vehicle, e.g., a rear portion of the vehicle. As shown, a motor housing casting 38 (schematically shown in dashed lines in FIG. 2) of an electric motor 37 is coupled to the bottom surface 29 of the front rails 36 of the body in white structure 32, 44, 48 at a series of electric motor attachments 39. The motor housing casting 38 has a series of attachments 40, 44, 48 for connecting different vehicle components directly to the motor housing casting 38. More particularly, rather than using an independent multi-piece cradle for providing attachment of vehicle components, the motor housing casting itself includes attachments 40, 44, 48 for connecting vehicle components. As shown, the attachments 40, 44, 48 may include a pair of steering gear attachments 40 for being attached to steering gears 42, a plurality of control arm attachments 44 for being attached to control arms 46, and/or a pair of sway bar attachments 48 for being attached to a sway bar 50 of the vehicle.

The use of the motor housing casting 38 as an attachment point for the aforementioned components reduces the number of components required as it eliminates the need to use a multi-piece cradle to support the components. Rather, the motor housing casting 38 itself serves as a cradle assembly. This greatly simplifies assembly of the body assembly 30A, as all of the attachments 40, 44, 48 can be part of a single, easy to fabricate casting. Furthermore, the motor housing casting 38 provides cross-car stability in a lateral direction.

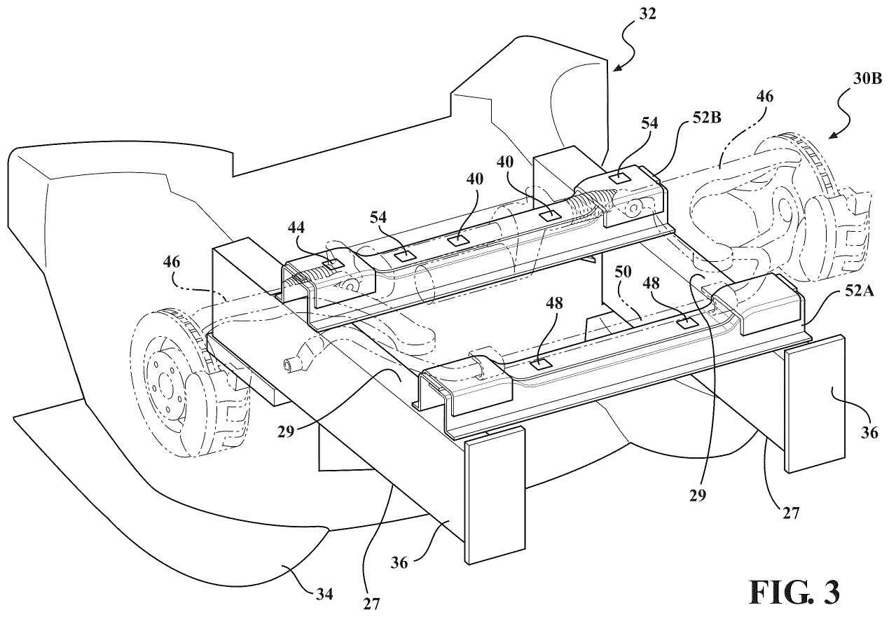

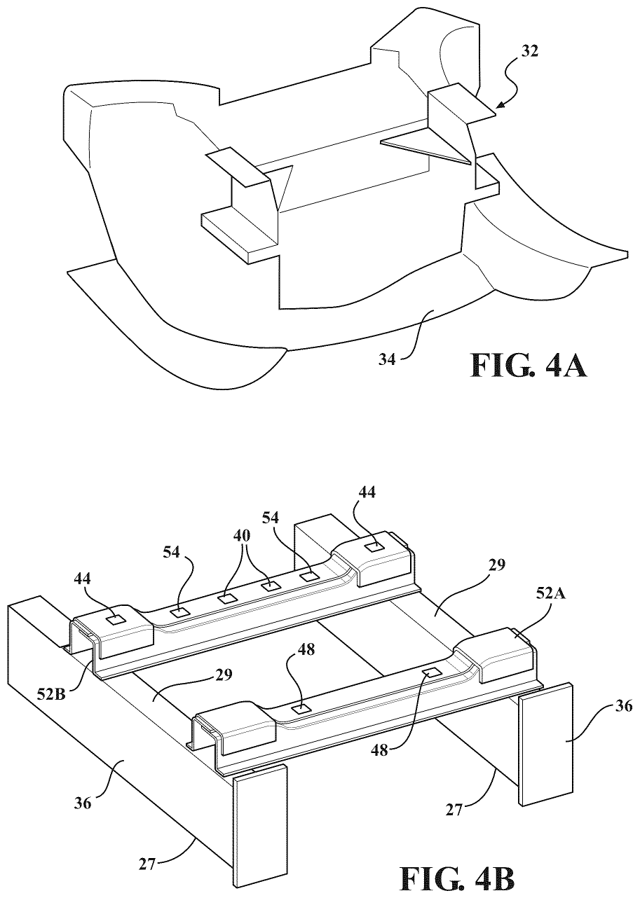

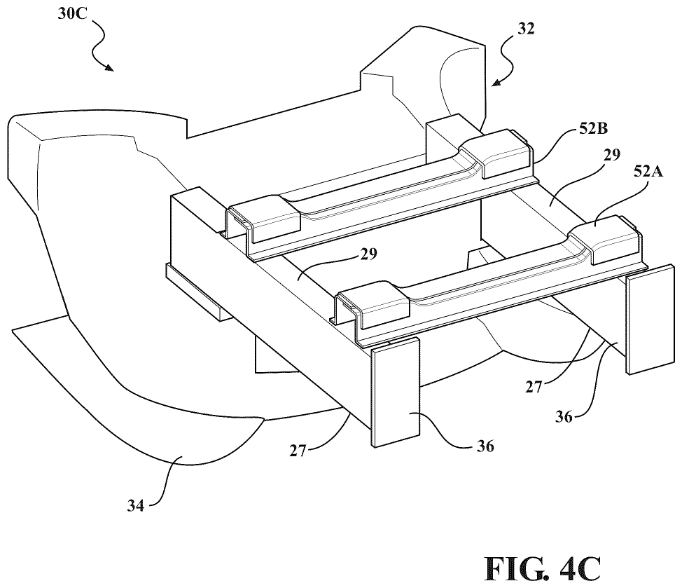

According to a second embodiment of the body assembly 30B shown in FIGS. 3-4C, the vehicle body assembly 30B includes a body in white structure 32 that has a front portion 34. A pair of front rails 36 extend in spaced and parallel relationship with one another. The front rails 36 each have a top surface 27 and a bottom surface 29. A front cross member 52A and a rear cross member 52B are coupled to the bottom surfaces 29 of the pair of front rails 36. The cross members 52A, 52B may be welded or otherwise permanently connected to the front rails 36 to permanently connect the cross members 52A, 52B to the front rails 36. Likewise, the front rails 36 may be welded or otherwise permanently connected to the body in white structure 32 such that the front rails 36 and cross members 52A, 52B are part of the body in white structure 32. The cross members 52A, 52B extend perpendicularly to the front rails 36 in parallel relationship with one another. The cross members 52A, 52B have a plurality of electric motor attachments 54 (schematically shown) for being attached to vehicle components such as an electric motor housing casting, a pair of steering gear attachments 40 for being attached to steering gear components 42, a pair of control arm attachments 44 for attaching to control arms 46, and/or a pair of sway bar attachments 48 for attaching to a sway bar 50 of the vehicle. According to an embodiment, electric motor housing casting attachments 54 and sway bar attachments 48 as well as other suspension component attachments may be connected to the front cross member 52A, while the steering gear attachments 40 and other steering assembly component attachments can be attached to the rear cross member 52B.

FIGS. 4A-4C illustrate steps for a method of assembling a third embodiment of the body assembly 30C. This embodiment is similar to the second embodiment of the body assembly 30B, but of note, the front rails 36 and cross members 52A, 52B are pre-assembled into a simple crib assembly prior to being connected to the body in white structure 32, whereas in the second embodiment of the body assembly 30B, the front rails 36 and cross members 52A, 52B are integrally connected with the body in white structure 32 during assembly thereof. As shown in FIG. 4A, the method may include providing the body in white structure 32. As shown in FIG. 4B, the method may also include attaching the front and rear cross members 52A, 52B to bottom surfaces of the front rails 36 to define a crib assembly. As shown in FIG. 4C, the method may further include securing the assembled crib assembly with front and rear cross members 52A, 52B and front rails 36 to the body in white structure 32 after the crib assembly has been assembled. The crib assembly may be attached with bolts or the like. The method may then include attaching vehicle components to attachments 40, 44, 48 on the cross members 52A, 52B.

Again, the arrangement of the front rails 36 and cross members 52A, 52B reduces the number of components on the body assembly 30B and simplifies construction of the body assembly 30B, as there is no need for a complex, multi-piece cradle assembly to hold components. Rather, the arrangement of the rails 36 and cross members 52A, 52B is comprised of few components and is simple to assemble. According to this embodiment, the cross-members 52A, 52B and front rails 36 may be integrated into/part of the body in white structure 32 to simplify construction.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. A vehicle body assembly, comprising:
a body in white structure having a front portion, and a pair of front rails extending in spaced and parallel relationship with one another at the front portion;
an electric motor having a motor housing casting coupled to the front rails of the body in white structure; and
the motor housing casting including at least one attachment for connecting to vehicle components.

2. The vehicle body assembly as set forth in claim 1, wherein the at least one attachment includes at least a pair of steering gear attachments for connecting steering gears of the vehicle to the motor housing casting.

3. The vehicle body assembly as set forth in claim 1, wherein the at least one attachment includes at least a pair of control arm attachments for connecting control arms of the vehicle to the motor housing casting.

4. The vehicle body assembly as set forth in claim 1, wherein the at least one attachment includes at least a pair of sway bar attachments for connecting a sway bar of the vehicle to the motor housing casting.

5. The vehicle body assembly as set forth in claim 1, wherein the at least one attachment is formed on the motor housing casting in a single casting operation.

6. A vehicle body assembly, comprising:
a body in white structure having a front portion;
the body in white structure including a pair of front rails at the front portion, the front rails extending in spaced and parallel relationship with one another, the front rails each having a top surface and a bottom surface;
a pair of cross members coupled to the bottom surfaces of the pair of front rails, the cross members extending transversely to the front rails in spaced relationship with one another; and
the cross members including at least one attachment for connecting to vehicle components.

7. The vehicle body assembly as set forth in claim 6, wherein the at least one attachment includes at least a plurality of electric motor attachments for being attached to an electric motor housing casting to connect the electric motor housing casting to the cross members.

8. The vehicle body assembly as set forth in claim 6, wherein the at least one attachment includes a pair of steering gear attachment for connecting steering gears of the vehicle to the cross members.

9. The vehicle body assembly as set forth in claim 6, wherein the at least one attachment includes a pair of control arm attachments for connecting control arms of the vehicle to the cross members.

10. The vehicle body assembly as set forth in claim 6, wherein the at least one attachment includes a pair of sway bar attachments for connecting sway bars of the vehicle to the cross members.

11. The vehicle body assembly as set forth in claim 6, wherein the cross members are connected to the front rails via a welded connection.

12. A method of assembling a vehicle body assembly, comprising:
connecting a pair of cross members to a pair of front rails, where the cross members extend transversely to the front rails to form a cradle assembly;
coupling the front rails to a body in white structure of the vehicle body assembly after connecting the pair of cross members to the pair of front rails; and
attaching at least one vehicle components to at least one attachment on the cross members.

13. The method as set forth in claim 1, wherein the cross member extend perpendicularly to the pair of front rails.

14. The method as set forth in claim 12, wherein the at least one attachment includes at least a plurality of electric motor attachments, wherein the at least one vehicle component includes an electric motor housing, and wherein the method further includes connecting the electric motor housing to the plurality of electric motor attachments.

15. The method as set forth in claim 12, wherein the at least one attachment includes a pair of steering gear attachments, wherein the at least one vehicle component includes a pair of steering gears, and wherein the method further includes connecting the steering gears to the pair of steering gear attachments.

16. The method as set forth in claim 12, wherein the at least one attachment includes a pair of control arm attachments, wherein the at least one vehicle component includes a pair of control arms, and wherein the method further includes connecting the control arms to the control arm attachments.

17. The method as set forth in claim 12, wherein the at least one attachment includes a pair of sway bar attachments, wherein the at least one vehicle component includes a sway bar and wherein the method includes connecting the sway bar to the sway bar attachments.
